(19) United States
(12) Patent Application Publication
(10) Pub. No.: US 2010/0205047 A1
(43) Pub. Date: Aug. 12, 2010

(54) Promotional Electronic Recipe Distribution

(76) Inventor: Denis Khoo, Arcadia, CA (US)

Correspondence Address: DENIS KHOO, 9729 CAMINO REAL, ARCADIA, CA, 91007, US

(21) Appl. No.: 12/370,400

(22) Filed: Feb. 12, 2009

(51) Int. Cl. G06Q 30/00; G06Q 50/00; H04L 9/32; G06F 17/30

(52) U.S. Cl. 705/14.1; 726/6; 726/27

(57) ABSTRACT

A method and system is described distributing electronic recipes within an electronic cookbook system. The electronic cookbook system is comprised of an electronic cooking device, electronic cooking server, and preferably and electronic cooking website. Particularly, a method and system of distributing a promotional electronic recipe is described, wherein the promotional electronic recipe is efficiently received, stored, and organized by a user's electronic cookbook device.

### BACKGROUND OF THE INVENTION

1. Field of the Invention

The present invention relates generally to an electronic cooking recipe. More specifically, the invention relates to a method and system for distributing electronic cooking recipes.

2. Description of the Related Art

Traditional print cookbooks contain a set of cooking recipes. A recipe is typically comprised of an image, listing of ingredients, listing of instructions, and other miscellaneous information such as title, description, cooking time, preparation time, nutritional facts, and serving size. Most cookbooks will contain recipes which centralize around a theme. The theme may be a cuisine (e.g. Chinese, French), course (e.g. Breakfast, Lunch), health (e.g. Vegetarian, Low Fat), ingredient (e.g. Chicken, Yams), or preparation method (e.g. Slow Cooker, BBQ Grill).

As with most industries where content is involved, the cookbook industry is going digital. Recipe websites such as Allrecipes.com, epicurious.com, and foodnetwork.com are popular destinations for consumers to find, share, and organize recipes. Typical of websites, these recipe sharing websites require an internet connection and all data is stored on the server side.

There are also recipe software applications that consumers can buy and install on their computers. Recipe software assists consumers in organizing their recipes in an electronic format locally on their computer. They may also help with meal planning.

In all of the examples above, the consumer accesses the recipe using a conventional computing device, such as a desktop, laptop, pda, or mobile phone. These conventional computing devices do not fare well when used in the kitchen. Cooks of course need access to recipes while in the kitchen, and often handle ingredients that are hazardous to a conventional computing device. For example, food particles may fall into a keyboard, eventually impairing the keyboard. Grease and food particles may smudge a touchscreen, making it difficult to see the screen, and possibly damaging resistive touchscreens. Because of this, most cooks will print the recipe and take the printed page into the kitchen when cooking.

Now, let's turn our attention to a different but related topic. Cooking product companies often provide free cookbooks in print form. For example, a kitchenware maker of a slow cooker may include a free cookbook with the purchase of its slow cooker. The free cookbook will naturally contain recipes which utilize that particular slow cooker. In another example, a spice maker may provide a consumer with a free cookbook if they purchase three products. In this example, much like a rebate, the consumer fills out a form and attaches the proof of purchase of three of the purchased products and sends it via postal mail. A few weeks later, the promotional cookbook will arrive. This promotional cookbook will likely contain recipes which use products sold by the spice maker. These promotional cookbooks are mutually beneficial for the consumer and provider. The consumer receives free recipes and the provider receives branding and advertising for its products. Unfortunately, these print cookbooks often get lost, tossed out, or damaged in the kitchen.

Some of the promotional cookbooks have gone digital to some extent. Some providers will allow the consumer to download a PDF version of a cookbook rather than mailing a physical print copy. This has not been popular, as consumers do not find it convenient to print out the PDF or to properly store the PDF file for future access.

As has been shown, accessing a recipe on a conventional computing device in a kitchen setting is not ideal. In addition, there needs to be a more efficient and effective means for kitchenware and cooking related product providers to distribute their promotional recipes.

### SUMMARY OF THE INVENTION

The present invention provides an improved electronic cookbook system. The electronic cookbook system is comprised of an electronic cookbook device, electronic cookbook server, and electronic cookbook website. The electronic cookbook device is a device with customized hardware and software for the primary purpose of being an electronic cookbook for in-kitchen use. The electronic cookbook device communicates with the electronic cookbook server using a data network or through the manual copying of files via memory stick/card. The electronic cookbook server contains electronic recipes which may be loaded onto the electronic cookbook device.

Through this electronic cookbook system, the present invention also provides an improved method of handling the access and distribution of promotion recipes.

All objects, features, and advantages of the present invention will become apparent in the following detailed description.

### BRIEF DESCRIPTION OF THE DRAWINGS

A more complete appreciation of the invention and many of the advantages thereof will be readily obtained as the same becomes better understood by reference to the detailed description when considered in connection with the accompanying drawings, wherein:

FIG. 1 is a front view of an embodiment of an electronic cookbook device;

FIG. 2 is a side view of an embodiment of an electronic cookbook device;

FIG. 3 is a block diagram of an embodiment of an electronic cookbook device;

FIG. 4a is a UI view showing a list of Collections of an embodiment of an electronic cookbook device;

FIG. 4b is a UI view showing a list of Cookbooks of an embodiment of an electronic cookbook device;

FIG. 4c is a UI view showing a list of recipes of an embodiment of an electronic cookbook device;

FIG. 4d is a UI view showing a recipe of an embodiment of an electronic cookbook device;

FIG. 4e is a UI view showing a recipe of an embodiment of an electronic cookbook device;

FIG. 5 is a block diagram of the database schema utilized by an embodiment of an electronic cookbook device;

FIG. 6 is a block diagram of the communication within the electronic cookbook system.

FIG. 7 is a block diagram of the software components on the electronic cookbook server;

FIG. 8 is a flow chart diagram of a process for entering an access code on an electronic cookbook device; and

FIG. 9 is a flow chart diagram of a process for entering an access code on a electronic cookbook website.

### DETAILED DESCRIPTION OF THE PREFERRED EMBODIMENT

The present invention, at a high level, is an electronic cookbook system. The electronic cookbook system is comprised of an electronic cookbook device, electronic cookbook server, and electronic cookbook website. The electronic cookbook server and electronic cookbook website may be located on the same server, comprised of multiple servers, or located separate from one another but connected via a data network. A detailed description of the electronic cookbook device, including the details of the present invention's preferred embodiment of an electronic recipe will be provided first. Then a detailed description of the electronic cookbook server and electronic cookbook website will be provided. Finally, after an understanding of the electronic cookbook system has been provided, a method for distributing electronic recipes, preferably for promotional purposes, will be described.

An electronic cookbook device is designed for use in the kitchen, and in particular, for use while cooking. When cooking in the kitchen, the user is expected to be handling several food products, both liquids and solids, which can be hazardous to conventional computing devices. In addition, it is expected that the user will be busy preparing and cooking, and will want to easily and quickly interface with an electronic cookbook device. As such, an electronic cookbook device can be operated without a keyboard or mouse. The electronic cookbook device is preferably operated using touch buttons or touchscreen, which is located at the front face of the electronic cookbook device. The electronic cookbook device allows a user to browse for recipes or search for recipes. The electronic cookbook device stores electronic recipes locally on internal storage.

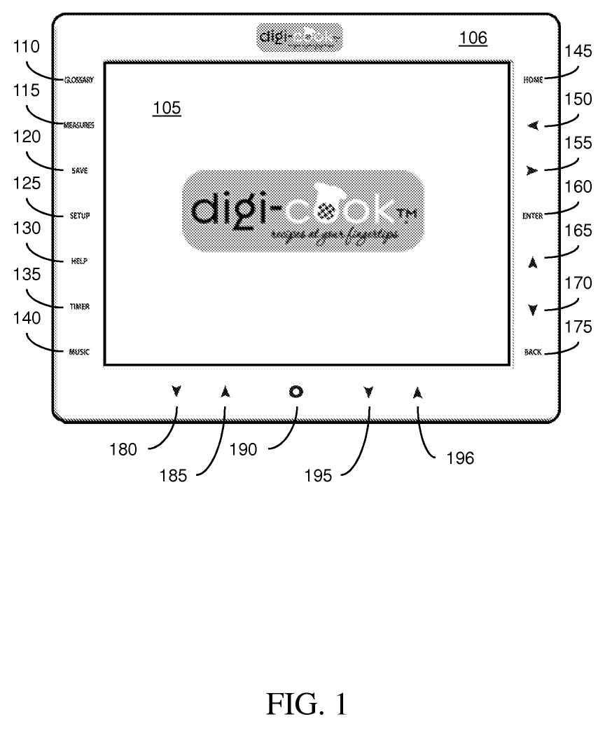

Referring to the drawings, FIG. 1 depicts a frontal view of one embodiment of the electronic recipe device. This is the view that the user of the device would typically see. The display 105 is a flat screen display, which can be of various display technologies, including LCD, plasma, OLED, PDP, and other display technologies capable of producing a flat screen display. The frame 106 which wraps around the display 105 contains a set of touch buttons on the left, right, and bottom of the display. The display 105 and frame 106 are enclosed under a protective layer of transparent material, such as acrylic, glass or plastic. This protective, transparent material serves two purposes: 1) it protects the display from being easily damaged and 2) it allows the user to easily clean the front of the device which will often touched by dirty kitchen fingers. The touch buttons are preferably capacitive sensing buttons, as opposed to resistive buttons which require pressure and movement for the buttons to be pressed. Using capacitive sensor technology allows for the single solid protective layer of glass or plastic to cover the display 105 and frame 106.

The touch buttons are configured in the arrangement as seen in FIG. 1, but could of course be in any arrangement and could be comprised of more or fewer touch buttons with differing functionality and labels. In another embodiment of the present invention, the electronic cooking device may use a touchscreen only or a combination of touchscreen and touch buttons in the frame 106. The advantage of a touchscreen is that it can improve the usability, while the disadvantage of a touchscreen is that it will force dirty kitchen fingers to touch the display 105, leaving behind food smears and particles and reducing visibility of what is displayed.

The touch buttons support a number of functions as can be seen from the set of touch buttons on the left, including Glossary 110, Measure 115, Save 120, Setup 125, Help 130, Timer 135, and Music 140. There are touch buttons along the bottom and right which serve as soft buttons or universal buttons, which serves multiple purposes depending on the page that the device is displaying. These include Home 145, Main Left 150, Main Right 155, Enter 160, Main Up 165, Main Down 170, Back 175, Ingredient Down 180, Ingredient Up 185, Circle Select 190, Instruction Down 195, and Instruction Up 196.

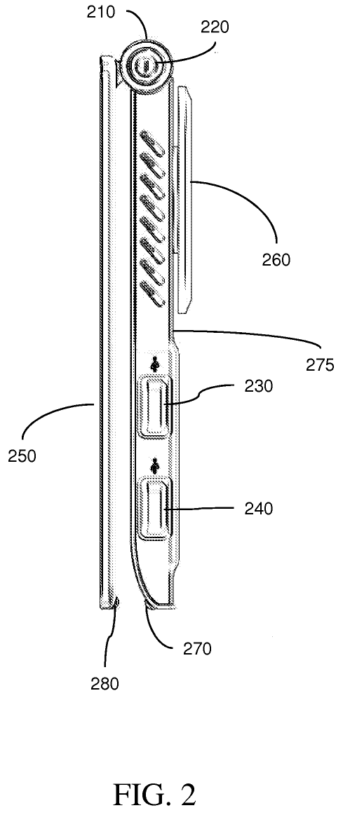

To get another perspective of an electronic cookbook device, refer to FIG. 2 for a side view of one embodiment of the electronic recipe device. In FIG. 2, the front screen 250 that the user views can be seen on the left. Behind the front screen 250 is the base 275 of the device. The base contains the PCBA for the device, which contains the processor and RAM. The device has one or more expandability slots 230 240 for accessories, such as a kitchen safe keyboard, kitchen thermometer, or mini-printer. These expandability slots 230 240 can be a USB slot, firewire slot, serial port, or other slots that support electronic components. The power button 220 allows for the device to be turned on and off. The front screen 250 and base 275 are connected by a swivel 210. This swivel allows the electronic cookbook device to be mounted in three ways. As shown in FIG. 2, the unit can be mounted to a wall by attaching the base plate 260 to the wall. The device can be stood on a countertop by expanding the swivel 210 about thirty to ninety degrees to form an upside down “V” shape. In this mode, a non-skid substance 280 270 would prevent the device from sliding on the countertop. And finally, the device can be mounted under a cabinet by attaching the base plate 260 under the cabinet. In another embodiment, the PCBA is located directly behind the display 250, and the base 275 is used for mounting and standing on a countertop. In yet another embodiment, the PCBA is located directly behind the display 250 and does not have a swivel 210 or base 275.

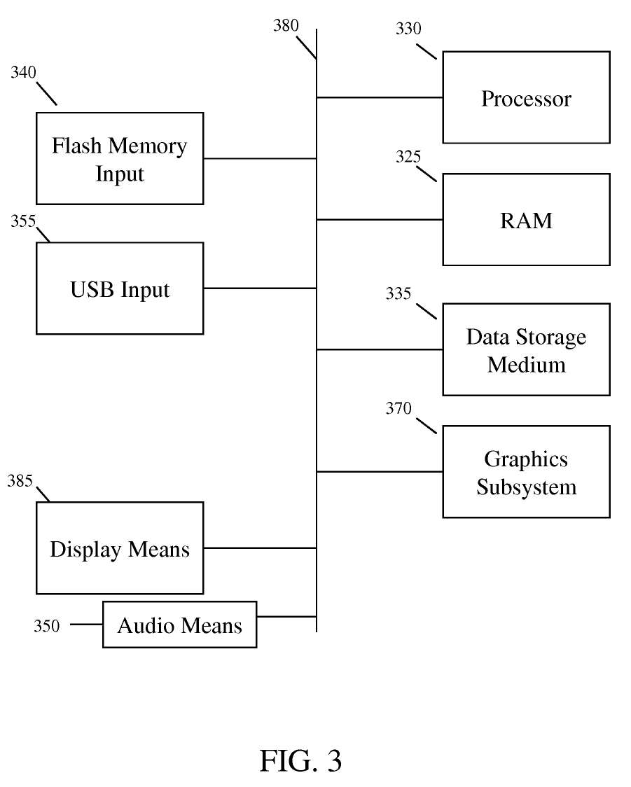

In one embodiment of an electronic cookbook device, the hardware is comprised of the components shown in the block diagram of FIG. 3. The electronic cookbook device contains at least one processor 330 which is coupled to the system bus 380. The processor 330 is a general purpose processor that, during normal operation, processes data through the operating system and application software in RAM 325. Data required to be persisted by the operating system or application software is stored in a data storage medium 335. The data storage medium is capable of persisting data, and can be a hard drive, flash memory, or other type of physical media capable of persisting data. The operating system or application software utilizes the graphics subsystem 370 and the display means 385 to present a visual image to the user. Audio may also be provided via the audio means 350. The device may accept various types of external flash memory, such as SD, xD, MMC, Memory Stick, Compact Flash, and the like through the Flash Memory Input 340. The USB Input 355 allows for the input of peripherals, such as a keyboard, mouse, printer, kitchen thermometer, and USB memory stick.

In one embodiment of the electronic cookbook device, the operating system is embedded Linux running a C++ software application. The data is stored on the Linux file system and also in a MySQL database.

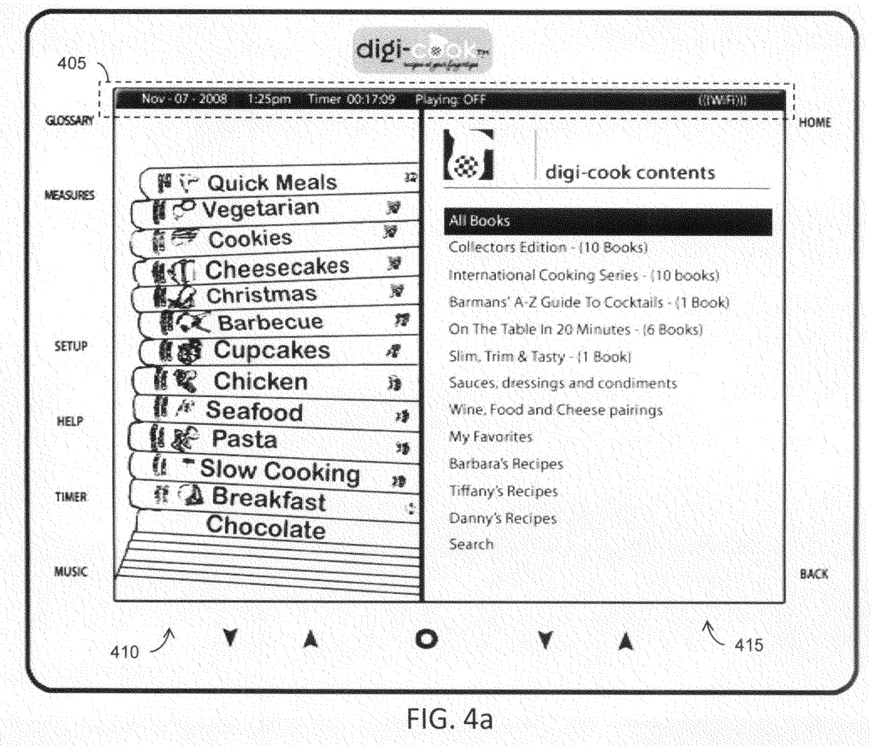

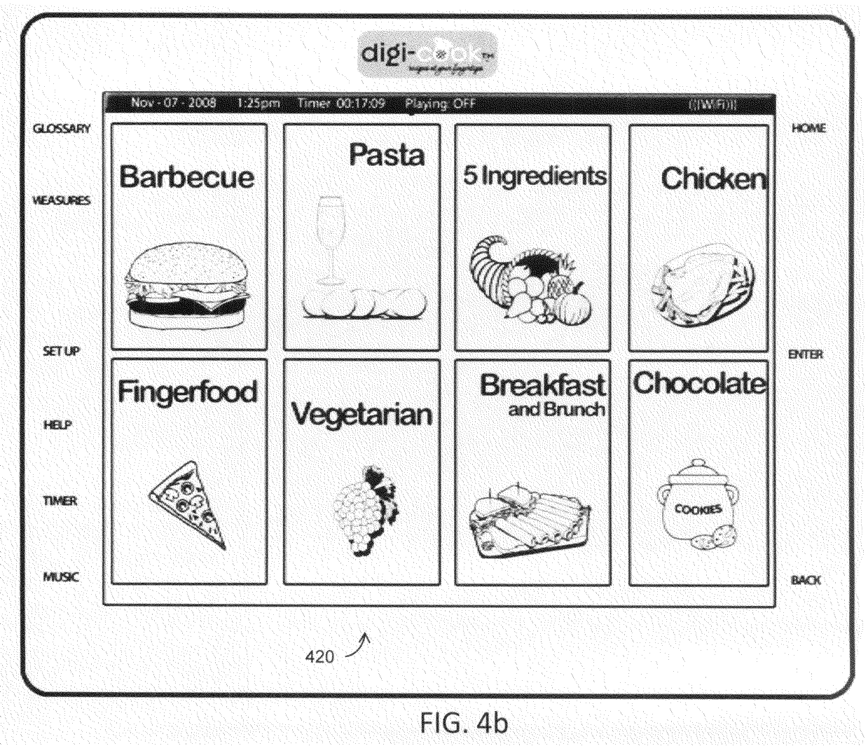

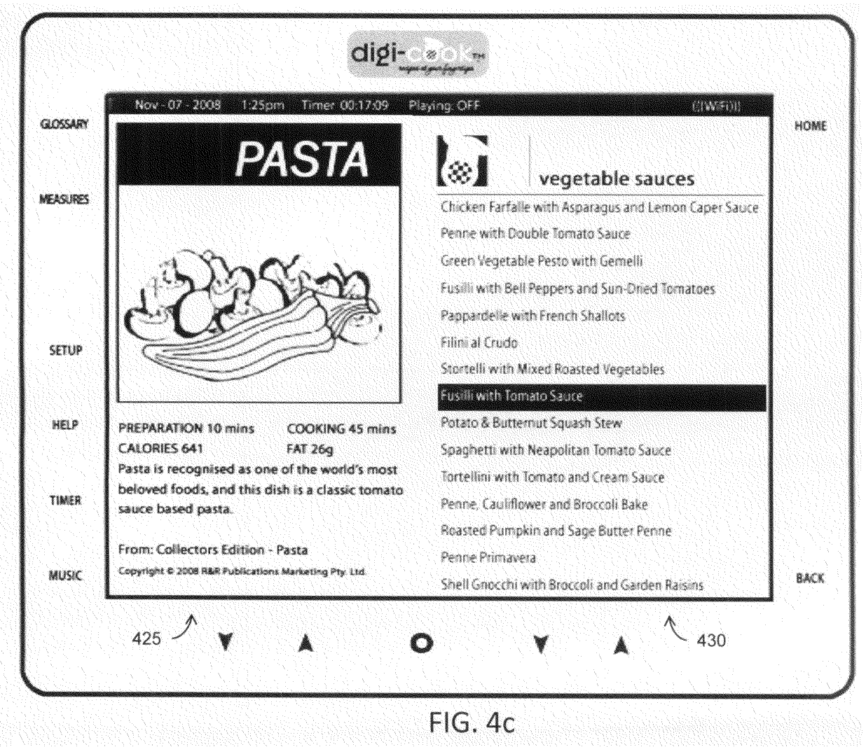

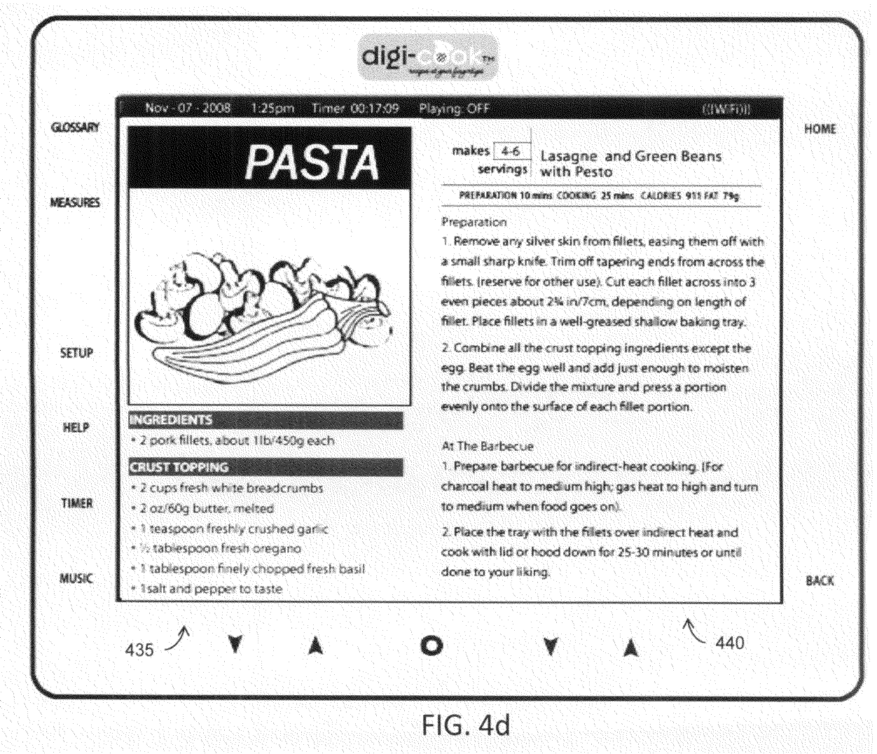

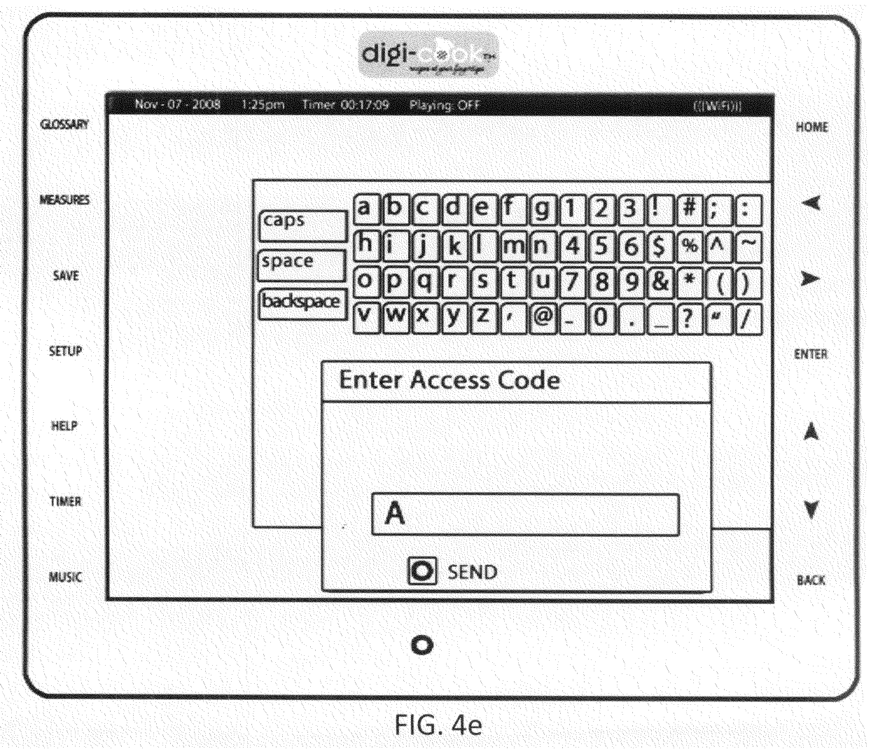

FIGS. 4a, 4b, 4c, 4d, and 4e depict software screenshots of one embodiment of the electronic cookbook device. FIG. 4a is a screenshot of the homepage of the electronic cookbook device. There is a status bar 405 at the top of the display which shows information such as the date and time, timer status, wifi status, and music player status. This status bar 405 is displayed on most pages. The homepage is divided into two sections. The left section 410 shows an image based on what is selected in the right section 415. The right section 415 displays options for the user to view All Cookbooks, a particular Collection of Cookbooks, My Favorites, a user's stored recipes, or to perform a Search. If the user selects to view All Cookbooks or a particular Collection of Cookbooks, FIG. 4b will be displayed, showing the Cookbook covers. Once the user selects a Cookbook, the user may be presented with a Table of Contents for that Cookbook if it exists. If the user selects a selection from the Table of Contents then FIG. 4c would be displayed. If a Table of Contents does not exist for the Cookbook, FIG. 4c would be displayed after selecting a Cookbook cover from FIG. 4b. FIG. 4c shows a listing of recipes 430. As the user scrolls through the listing of recipes 430, the left section 425 displays a photo of the recipe and some information. A user selects a recipe and the recipe is displayed to the user in FIG. 4d. The left section 430 displays a photo of the recipe and the listing of ingredients. The right section 440 displays information about the recipe and the listing of instructions.

FIG. 4e depicts a screenshot where the user can enter an Access Code. This will be covered in more detail further below.

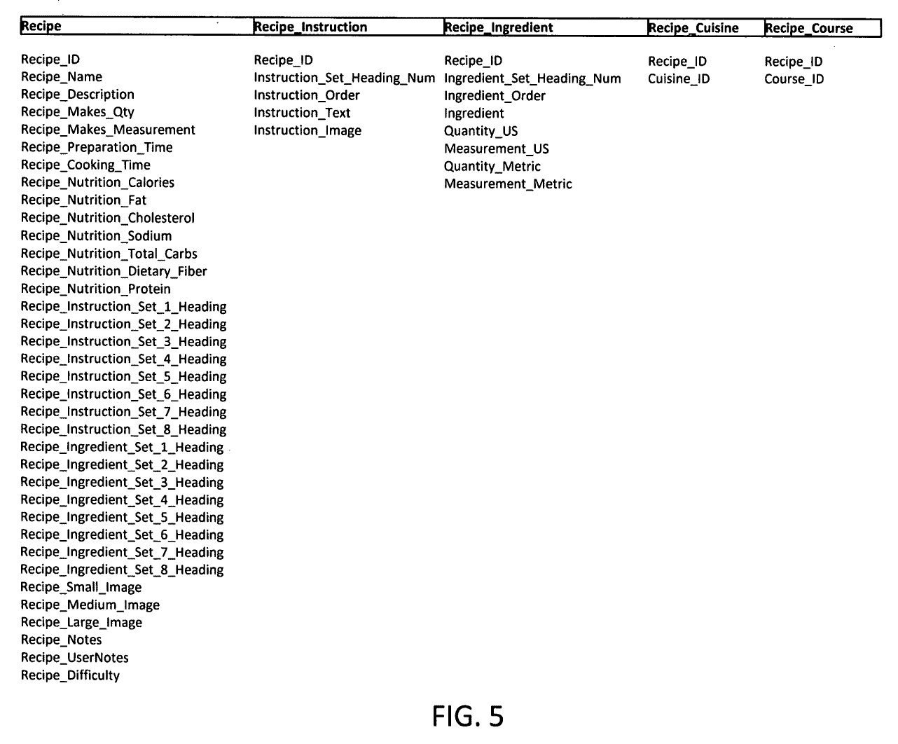

Recipes are stored locally on the electronic cookbook device. The recipes are stored on a local database and are stored in a structured format, as opposed to a single image or single PDF file. One embodiment of the structured format can be seen in the data schema as depicted in FIG. 5. As can be seen, recipes are comprised of many individual data fields. There may be multiple sets of ingredients and multiple sets of instructions. Each ingredient may contain either or both metric and imperial units. The quantity of the ingredient is separated out, as well as the measurement. Having recipe data structured in such a fashion allows for more robust features. For example, by having a highly structured format, the electronic cookbook device may support the ability for the user to change the serving size of the recipe, which will automatically adjust the quantity and measurement of each of the ingredients. In addition, the recipe data structure allows for more flexibility in how the recipe is displayed. Perhaps most compelling is that users of the electronic cookbook device may be able to perform robust searches for recipes due to having the recipes in a structured format. For example, a user may be able to search for all recipes that are of “Chinese” or “Japanese” cuisine, and have less than 500 calories. Or in another example, users can search for all recipes within the “Fresh and Tasty” Collection that take less than 30 minutes to prepare and cook.

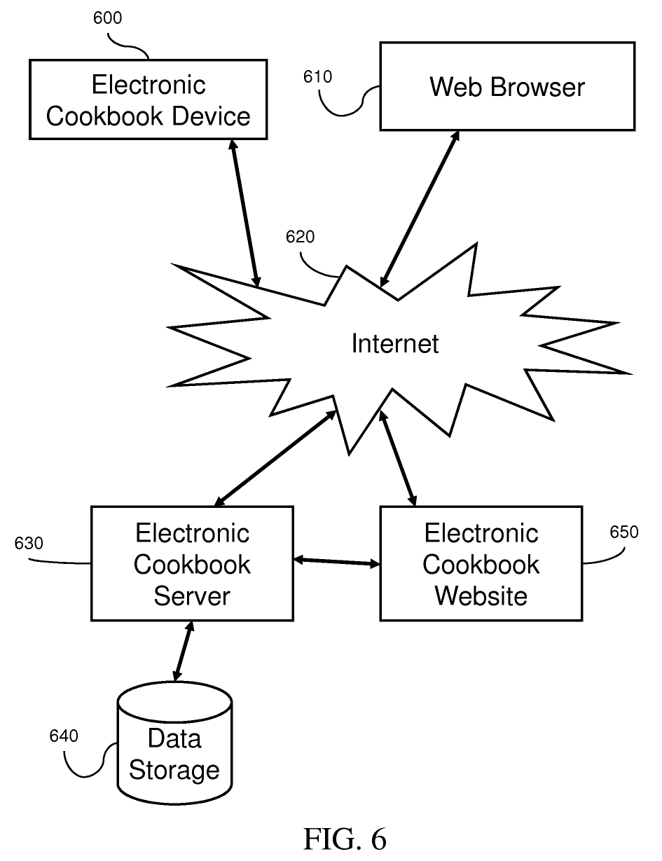

FIG. 6 shows how the different components of the electronic cookbook system fit together. The electronic cookbook device 600 communicates with the electronic cookbook server 630 via the internet. The electronic cookbook server 630 will make certain services available to the electronic cookbook device 600. In order to prevent hackers from getting access to these services, some form of device authentication is preferably followed to be sure that an electronic cookbook device is utilizing the service as opposed to a hacker. Device authentication is the technique for giving software authentic information about what sort of hardware it is communicating with. One method of device authentication is to have the serial number and MAC address of the device be sent to the electronic cookbook server 630 each time services are accessed. The electronic cookbook server 630 can keep a record of the serial numbers and MAC addresses of existing electronic cookbook devices, which can be used for cross referencing in the device authentication process. It is important to be understood that there are several other device authentication methods known to those skilled in the art which can be utilized, including cryptographic smartcards, digital certificate, and Microsoft's Protected Media Path (PMP).

Referring back to FIG. 6, there may also be an electronic cookbook website 650 that accesses the functions and data from the electronic cookbook server 630. As mentioned earlier, the electronic cookbook website 650 and electronic cookbook server 630 may be different servers or combined on a single server. The user would access this electronic cookbook website 650 using a web browser 610. The electronic cookbook server 630 stores recipe data in a data storage 640, which is usually a database. The data storage 640 may contain purchasable electronic cookbooks (eCookbooks), user entered recipes, or promotional electronic cookbooks (eCookbooks). The data storage 640 maintains a repository of all these user recipes and electronic cookbooks, and the electronic cookbook server 630 provides access to this data.

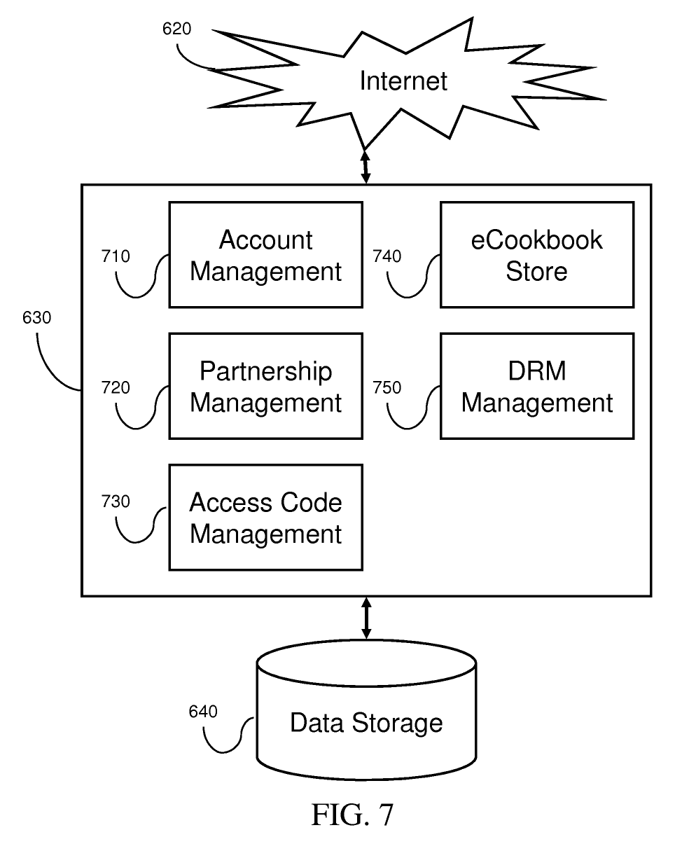

A component diagram of the electronic cookbook server 630 can be seen in FIG. 7. As shown, the electronic cookbook server has components for Account Management 710, Partnership Management 720, Access Code Management 730, eCookbook Store 740, and DRM Management 750. The Account Management 710 controls user accounts within the system. A user may register for an account using a web browser 610 or directly through the electronic cookbook device 600. The Partnership Management 720 keeps track of what electronic cookbook device a particular user owns and is associated with. There is preferably an authentication process to determine this partnership. For example, if a user signs up for an account using a web browser 610, the user will provide the serial number and preferably MAC address of the electronic cookbook device that the user owns. However, the electronic cookbook server cannot know for sure that the user does indeed have access to that particular electronic cookbook device. To verify this, the Partnership Management 720 generates a random verification code, which is displayed to the user via the web browser 610. The user must enter this verification code on the user's electronic cookbook device. Once entered on the electronic cookbook device, the device will send the verification code to the electronic cookbook server. If the verification code matches, then the partnership between the user and the electronic cookbook device is established. By forming a partnership, any recipes for that user can automatically be sent to the electronic cookbook device partnered with that user. So if the user purchases an eCookbook through the eCookbook Store 740, that user would be given access to the purchased eCookbook via the DRM Management 750, and that eCookbook could automatically be sent to the electronic cookbook device partnered with that user.

So far, it has been assumed that the user's electronic cookbook device can communicate with the electronic cookbook server via a data network. However, there may be cases where an electronic cookbook device may not be able to communicate with the electronic cookbook server via a data network. In such a case, it is possible for the user to download a file via a web browser 610 containing the eCookbook. The file may be encrypted and DRM may only allow that eCookbook to be loaded onto the electronic cookbook device matching the serial number and MAC address entered by the user. The user would download this file, copy it to a USB memory stick or other types of flash memory such as SD, MMC, xD, or MemoryStick. The user would then insert that flash memory into the user's electronic cookbook device, which would load the eCookbook into the local storage on the device, allowing the user to view the eCookbook from the device.

The Access Code Management 730 on the electronic cookbook server controls access to promotional eCookbooks. The general purpose of the Access Code Management is to manage access codes which are associated with a promotional eCookbook. When a user provides an access code to the Access Code Management 730, the user may receive a promotional eCookbook for free. As described earlier, if a user has a partnership with an electronic cookbook device, this promotional eCookbook can be automatically sent to that electronic cookbook device for local storage and viewing by the user.

The Access Code Management 730 supports both multiple-use access code and one-time use access code. A multiple-use access code is an access code that can be used more than once. The number of times it can be used is predetermined and stored. The number of times can be infinite. An explicit maximum use quantity may not need to be stored if all access codes can be used for the same number of times. For example, all access codes can either be used just once, twice, or infinitely. The Access Code Management 730 will allow keep track of how many times the access code has been utilized and make sure that it does not exceed the maximum usage. A one-time use access code can only be used once. Once a user uses a one-time use access code, it can no longer be used by anyone else.

Access codes are associated with a particular promotional eCookbook. A user may need to enter just one access code or more than one access code in order to be entitled to receive the associated promotional eCoookbook. The Access Code Management 730 keeps track of access codes entered by the user. Prior to distributing access codes to users, the electronic cookbook server 630 must be preprogrammed with the access codes which will be distributed. This is done by storing a list of access codes in the data storage 640. These preprogrammed access codes stored in the data storage 640 are associated with one or more promotional eCookbook. If required, information about the number of access codes required to receive a promotional eCookbook is stored. Also if required, the number of times each preprogrammed access code can be used is stored. Also if required, the expiration date of each preprogrammed access code is stored. It is also possible to associate each preprogrammed access code with a point system. This allows each preprogrammed access code to have a different point or weight. For example, to receive the promotional eCookbook, a total of 10 points may be required. A user may enter a first access code which gives the user 3 points, and enter a second access code which gives the user 8 points. After having done so, the user has a total of 11 points, and thus is qualified for the promotional eCookbook with requires 10 points. Once these programmed access codes are properly stored into the data storage 640, these access codes can be distributed to users.

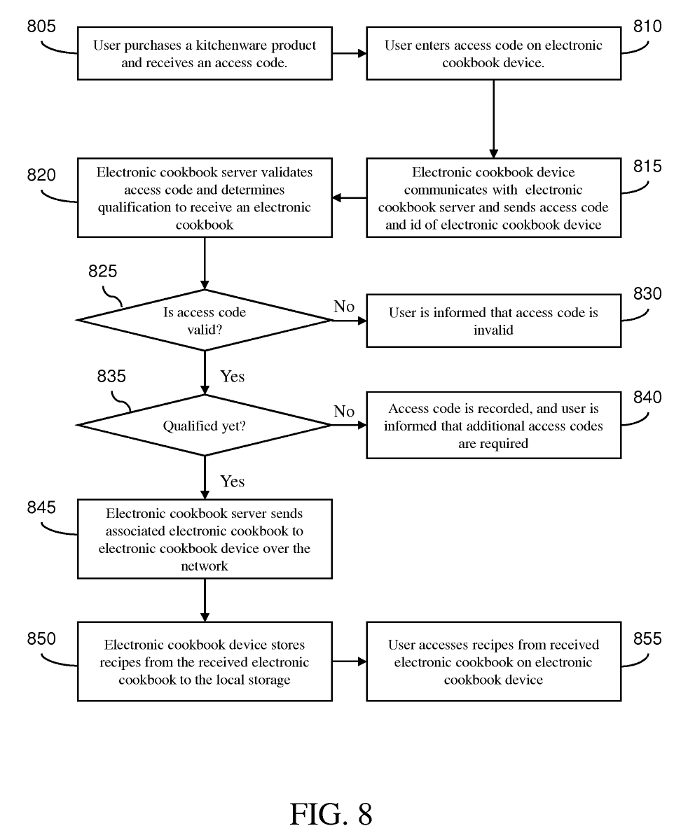

Refer to FIG. 8 for a flowchart of the steps on how an access code works. This flowchart assumes that the electronic cookbook device is able to communicate with the electronic cookbook server via a data network, such as the internet. In the first step 805, the user purchases a kitchenware or cooking-related product and receives a distributed access code. Of course, there are various other ways in which the user may receive a distributed access code, and step 805 shows one embodiment. In step 810, the user enters this distributed access code on the user's electronic cookbook device. This can be seen in the screenshot of FIG. 4e. In step 815, the electronic cookbook device communicates with the electronic cookbook server and sends the distributed access code entered by the user. The Access Code Management 730 will process this distributed access code to determine validity and qualification of the distributed access code, as seen in step 820. The distributed access code is invalid if it does not match the set of preprogrammed access codes in the system, is expired, or if it has already been used the maximum number of times. In step 825, if the distributed access code is invalid, the user is informed, and the flowchart ends.

If the distributed access code is valid, the Access Code Management 730 will determine if the user is qualified for the associated promotional eCookbook. For example, if the associated promotional eCookbook requires that three valid access codes be entered, and the user has just entered a first one, then the user is not yet qualified. Step 840 shows that if the user is not qualified, the user is notified of this and the flowchart ends.

If the user is qualified to receive the promotional eCookbook after entering the distributed access code, then in step 845, the electronic cookbook server will send the promotional eCookbook to the user's electronic cookbook device. In step 850, the user's electronic cookbook device receives the promotional eCookbook and stores it in local storage. Now in step 855, the user is able to access and view the newly loaded promotional eCookbook.

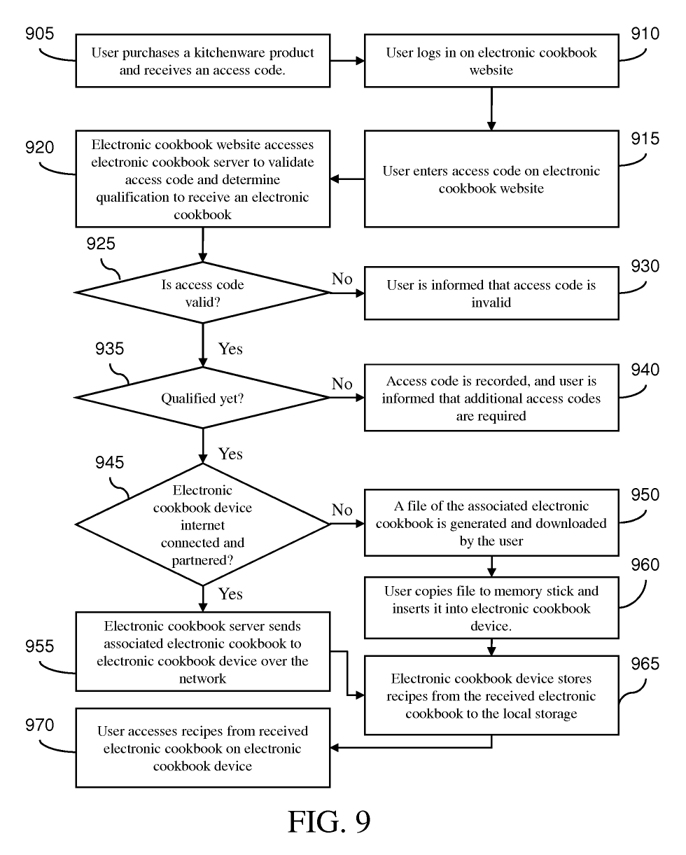

The flowchart in FIG. 9 is similar to the flowchart of FIG. 8, except that the user enters the distributed access code using a webs browser instead of entering it directly on the electronic cookbook device. As before, in step 905, the user purchases a kitchenware or cooking related product and receives a distributed access code. The user logs in to the electronic cookbook website in step 910. Once logged in, the user enters the distributed access code on the electronic cookbook website in step 915. In the next step 920, the electronic cookbook website communicates with the electronic cookbook server to validate the distributed access code and check to see if the user is qualified to receive the associated promotional eCookbook. The distributed access code is invalid if it does not match the set of preprogrammed access codes in the system, is expired, or if it has already been used the maximum number of times. In step 925, if the distributed access code is not valid, the user is informed in step 930. In step 935, if the user is not qualified yet for the associated promotional eCookbook, the user is informed in step 940. If the user is qualified, step 945 will determine how to send the associated promotional eCookbook to the electronic cookbook device. If the user has formed a partnership with the user's electronic cookbook device, meaning the device must have internet connectivity, the electronic cookbook server sends the associated promotional eCookbook to the user's electronic cookbook device over the internet in step 955. If the user does not have a partnership with an electronic cookbook device, the user is given the ability to download the associated promotional eCookbook in step 950. In step 960, the user copies this file onto flash memory and loads that flash memory into the user's electronic cookbook device. If DRM is enabled, the file may only be allowed to be loaded onto a digital cookbook device which matches the serial number and/or MAC address that the user originally entered. In step 965, the electronic cookbook device stores the promotional eCookbook onto the local storage. And finally in step 970, the user is able to access and view the promotional eCookbook directly from the electronic cookbook device.

The advantages of distributing a promotional cookbook as described in the present invention are many. The provider of the promotional eCookbook avoids the cost of printing a physical cookbook. The user no longer needs to fill out a form and mail it with proof of purchase. The user no longer needs to wait weeks to receive the promotional eCookbook. The provider no longer needs to handle fulfillment of shipping the physical promotional cookbook. When a user claims a promotional cookbook by entering an access code, information already known about that user by the electronic cookbook server can be provided to the promoter of the promotional eCookbook, allowing the promoter/provider to collect valuable data about their customers. The user is able to maintain a copy of the promotional eCookbook on the user's electronic cookbook device, thus keeping it organized amongst other eCookbooks and easy to access. The user is able to quickly and conveniently access the promotional eCookbook from within the kitchen, thus incurring more use of the promotional eCookbook. The increased use will result in greater advertising value and increased usage of the kitchenware product, thus resulting in higher customer satisfaction.

Although the present invention has been described in detail with respect to certain embodiments and examples, variations and modifications exist which are within the scope of the present invention as defined in the following claims.

What is claimed:

1. A method for distributing an electronic recipe, comprising the steps of:
storing at least one promotional electronic recipe at an electronic cooking server;
associating a preprogrammed access code with said at least one promotional electronic recipe and storing said preprogrammed access code and association at said electronic cooking server;
receiving a distributed access code by a user;
entering by said user, said distributed access code on an electronic cookbook device;
communicating said distributed access code from said electronic cookbook device to said electronic cookbook server;
verifying the validity of said distributed access code by comparing with said preprogrammed access code;
sending said at least one promotional electronic recipe from said electronic cookbook server to said electronic cookbook device; and
storing said at least one promotional electronic recipe on said electronic cookbook device locally.

2. The method of claim 1 wherein said at least one electronic recipe is in a structured format.

3. The method of claim 2 wherein said electronic cookbook device stores electronic recipes locally in said structured format.

4. The method of claim 1 wherein said receiving said distributed access code by said user occurs as a result of said user purchasing a cooking related product.

5. The method of claim 1 further comprising the step of setting a maximum number of usage for said preprogrammed access code, said maximum number of usage is stored at said electronic cookbook server.

6. The method of claim 5, said step of verifying the validity of said distributed access code by comparing with said preprogrammed access code further comprising the step of:
confirming said distributed access code has not exceed said maximum number of usage.

7. The method of claim 1, said step of verifying the validity of said distributed access code by comparing with said preprogrammed access code further comprising the step of:
confirming said distributed access code matches said preprogrammed access code and/or is not expired.

8. A method for distributing digital recipes, comprising the steps of:
storing at least one promotional electronic recipe at a electronic cookbook server;
associating a preprogrammed access code with said at least one promotional electronic recipe and storing said preprogrammed access code and association at said electronic cookbook server;
receiving a distributed access code by a user;
registering by said user on an electronic cookbook website;
creating a partnership between said user and an electronic cookbook device;
entering by said user, said distributed access code on said electronic cookbook website;
verifying the validity of said distributed access code by comparing with said preprogrammed access code;
sending said at least one promotional electronic recipe from said electronic cookbook server to said electronic cookbook device; and
storing said at least one promotional electronic recipe on said electronic cookbook device locally.

9. The method of claim 8 wherein said at least one electronic recipe is in a structured format.

10. The method of claim 9 wherein said electronic cookbook device stores electronic recipes locally in said structured format.

11. The method of claim 8 wherein said receiving said distributed access code by said user occurs when said user purchases a cooking related product.

12. The method of claim 8 further comprising the step of setting a maximum number of usage for said preprogrammed access code, said maximum number of usage is stored at said electronic cookbook server.

13. The method of claim 12, said step of verifying the validity of said distributed access code by comparing with said preprogrammed access code further comprising the step of:
confirming said distributed access code has not exceed said maximum number of usage.

14. The method of claim 8, said step of verifying the validity of said distributed access code by comparing with said preprogrammed access code further comprising the step of:
confirming said distributed access code matches said preprogrammed access code and/or is not expired.

15. A system for distributing an electronic recipe, said system comprising:
an electronic cookbook server with a plurality of preprogrammed access codes stored, wherein each said programmed is associated with at least one promotional electronic recipe; and
an electronic cookbook device capable of accepting a distributed access code from a user, wherein said distributed access code is sent to said electronic cookbook server via a data network for validation and qualification, and if said distributed access code is validated and qualified, said electronic cookbook server sends said at least one promotional electronic recipe to said electronic cookbook device for local storage and viewing on said electronic cookbook device.

16. The system of claim 15 wherein said distributed access code is received by said user by purchasing a cooking related product.

17. The system of claim 15 wherein said electronic cookbook server has a registration for said user and a partnership between said user and said electronic cookbook device.

18. The system of claim 15 wherein said electronic cookbook server stores the maximum usage for said preprogrammed access code.

19. The system of claim 15 wherein said at least one electronic recipe is in a structured format.
